(19) United States
(12) Patent Application Publication
(10) Pub. No.: US 2022/0222231 A1
(43) Pub. Date: Jul. 14, 2022

(54) COMPUTERIZED SYSTEMS AND METHODS FOR USING ARTIFICIAL INTELLIGENCE TO OPTIMIZE DATABASE PARAMETERS

(71) Applicant: Coupang Corp., Seoul (KR)

(72) Inventors: Bin Dong, Beijing (CN); Zhan Chen, Seattle, WA (US)

(73) Assignee: Coupang Corp.

(21) Appl. No.: 17/147,498

(22) Filed: Jan. 13, 2021

(51) Int. Cl. G06F 16/22; G06F 16/2457; G06F 16/2453; G06K 9/62

(52) U.S. Cl. CPC G06F 16/2237; G06K 9/6256; G06F 16/24542; G06F 16/2457

(57) ABSTRACT

Systems and method are provided for AI-based database parameter optimization. One method includes receiving, from a user device, a query; preprocessing the query; predicting a plurality of optimal parameters for executing the query, by: calculating a predicted change in database metrics based on the preprocessed query; sending the predicted change in database metrics to a tuner; calculating database performance metrics based on the predicted change in database metrics and current database performance metrics; and calculating a vector of optimal parameters based on the database performance metrics; and executing the received query based on the predicted plurality of optimal parameters.

### TECHNICAL FIELD

The present disclosure generally relates to computerized systems and methods for using artificial intelligence (AI) to optimize database parameters. In particular, embodiments of the present disclosure relate to inventive and unconventional systems that may automatically modify a user interface element based on a user identifier and a product identifier associated with a query by generating a model to generate a list of recommended products.

### BACKGROUND

Consumers often shop for and purchase various items online through computers and smart devices. These online shoppers often submit millions of queries every day while researching, evaluating, and purchasing multiple products. Additionally, millions of products are registered online by sellers every day. Online shopping engines that are not configured to process the inputs from consumers or sellers may severely reduce a user's experience by increasing latency and reducing workload balances.

Databases used in online shopping engines often involve hundreds of parameters, which require parameter tuning for data intensive applications. Database parameters are typically optimized based on database workloads rather than query patterns. Although parameter optimization on the query level exists, these methods only tune global parameters that are based on all client sessions and queries. Databases also require optimal workload balance strategies to reduce skews in data servers. However, general network load balancers often require additional operation and performance costs and are not aware of internal system metrics, such as server thread numbers.

Therefore, there is a need for improved methods and systems for optimizing database parameters so that consumers may quickly find and purchase products while online shopping and sellers may quickly register their products for sale.

### SUMMARY

One aspect of the present disclosure is directed to a system for AI-based database parameter optimization. The system may include a memory storing instructions and at least one processor configured to execute instructions. The instructions may include receiving from a user device, a query; preprocessing the query; predicting a plurality of optimal parameters for executing the query, by: calculating a predicted change in database metrics based on the preprocessed query; sending the predicted change in database metrics to a tuner; calculating database performance metrics based on the predicted change in database metrics and current database performance metrics; and calculating a vector of optimal parameters based on the database performance metrics; and executing the received query based on the predicted plurality of optimal parameters.

Another aspect of the present disclosure is directed to a method for AI-based database parameter optimization. The method may include receiving from a user device, a query; preprocessing the query; predicting a plurality of optimal parameters for executing the query, by: calculating a predicted change in database metrics based on the preprocessed query; sending the predicted change in database metrics to a tuner; calculating database performance metrics based on the predicted change in database metrics and current database performance metrics; and calculating a vector of optimal parameters based on the database performance metrics; and executing the received query based on the predicted plurality of optimal parameters.

Yet another aspect of the present disclosure is directed to a system for AI-based database parameter optimization. The system may include a memory storing instructions and at least one processor configured to execute instructions. The instructions may include receiving from a user device, a query; preprocessing the query; predicting, using a model, a plurality of optimal parameters for executing the query, by: calculating, using the model, a predicted change in database metrics based on the preprocessed query; sending the predicted change in database metrics to a tuner; calculating, using the tuner, database performance metrics based on the predicted change in database metrics and current database performance metrics; and calculating, using the model, a vector of optimal parameters based on the database performance metrics; and executing, using the tuner, the received query based on the predicted plurality of optimal parameters. The instructions may further include calculating, using the tuner, a performance score associated with the executed query; sending the performance score to the model; and updating network weights of the model based on the performance score

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts an exemplary network of devices and systems for AI-based database parameter optimization, consistent with the disclosed embodiments.

FIG. 4 depicts an exemplary process for AI-based database parameter optimization, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for AI-based database parameter optimization. The disclosed embodiments are capable of initializing a user's client session variables at connect time, thereby customizing predicted optimal parameters according to the client session context. A metrics repository system may preprocess the query by featurizing the query. In some embodiments, a model system may predict, using a model, a plurality of optimal parameters for executing the query. The optimal parameters may include at least one of client session database parameters, client session connection pool parameters, client session workload balance parameters, or data partitioning parameters.

In some embodiments, the model system may predict the optimal parameters by calculating, using the model, a predicted change in database metrics based on the preprocessed query. For example, the model system may predict the difference in database metrics from before execution of the query to after execution of the query. In some embodiments, the model system may send the predicted change in database metrics to a tuner system. The tuner system may calculate database performance metrics based on the predicted change in database metrics and current database performance metrics. For example, the tuner system may calculate database performance metrics by retrieving current (e.g., real-time) database performance metrics from the system and adding the predicted change in database metrics to the current database performance metrics.

In some embodiments, the model system may calculate a vector of optimal parameters based on the calculated database performance metrics and calculate a vector of optimal parameters based on the calculated database performance metrics. The tuner system may push the optimal parameters to an application and execute the query based on the predicted optimal parameters, thereby executing the query using optimal parameters specific to the client session and modifying the client session parameters in runtime. In some embodiments, the tuner system may calculate a performance score associated with the executed query. For example, the performance score may be calculated by determining a change in database performance metrics resulting from the executed query. In some embodiments, the tuner system may send the performance score to the model system and the model system may update the network weights of the model based on the performance score.

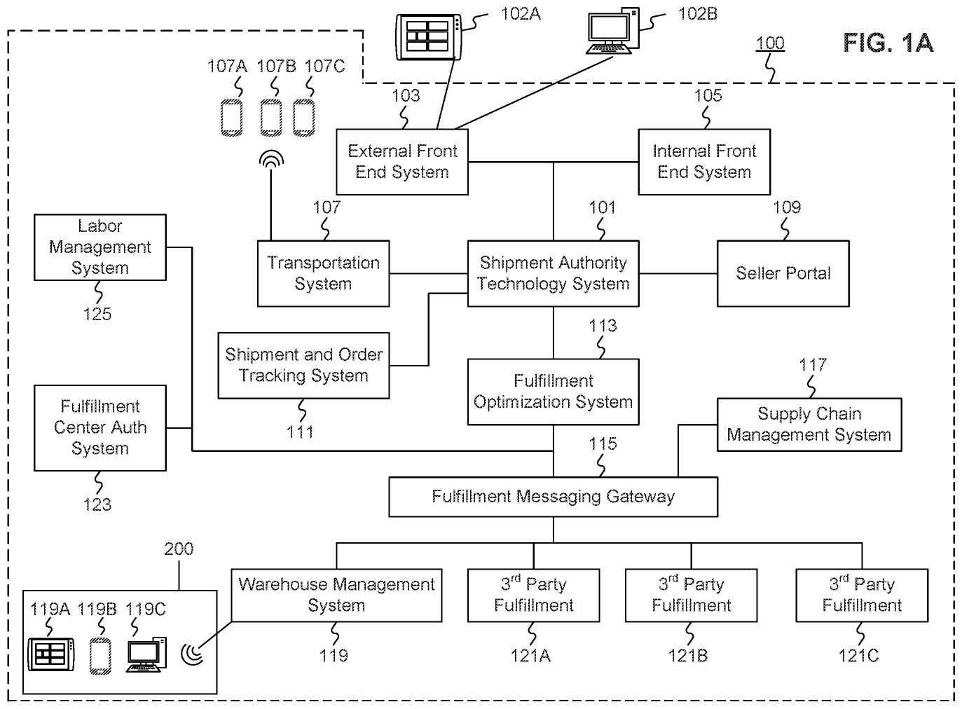

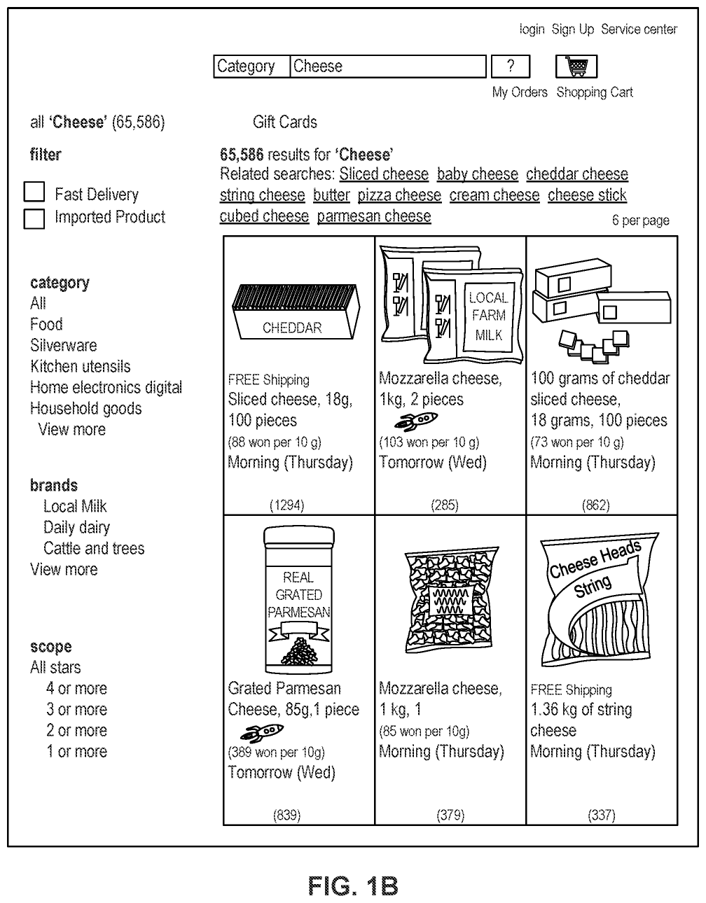

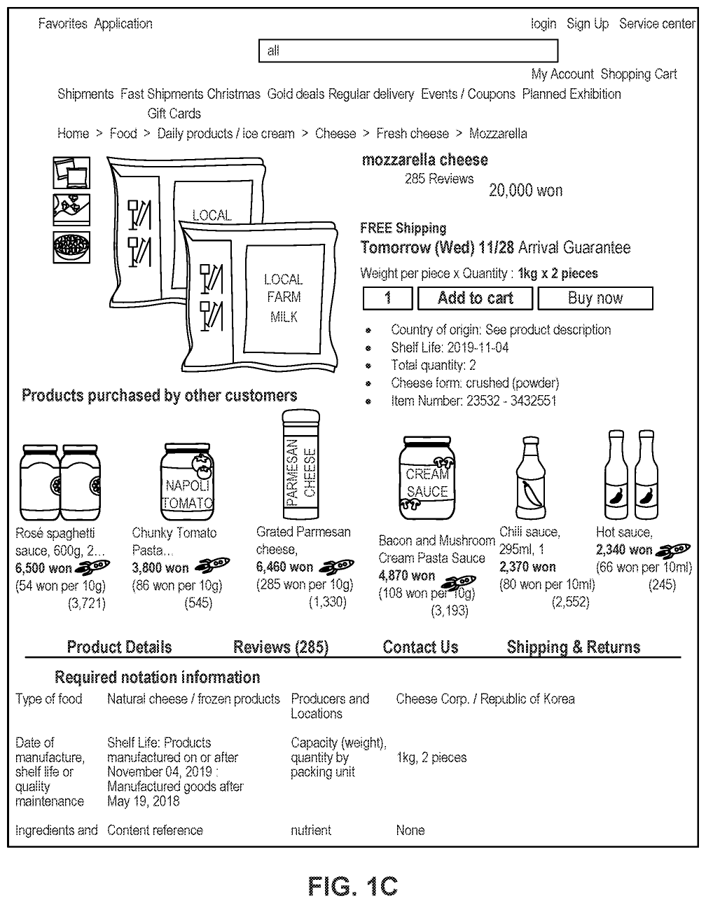

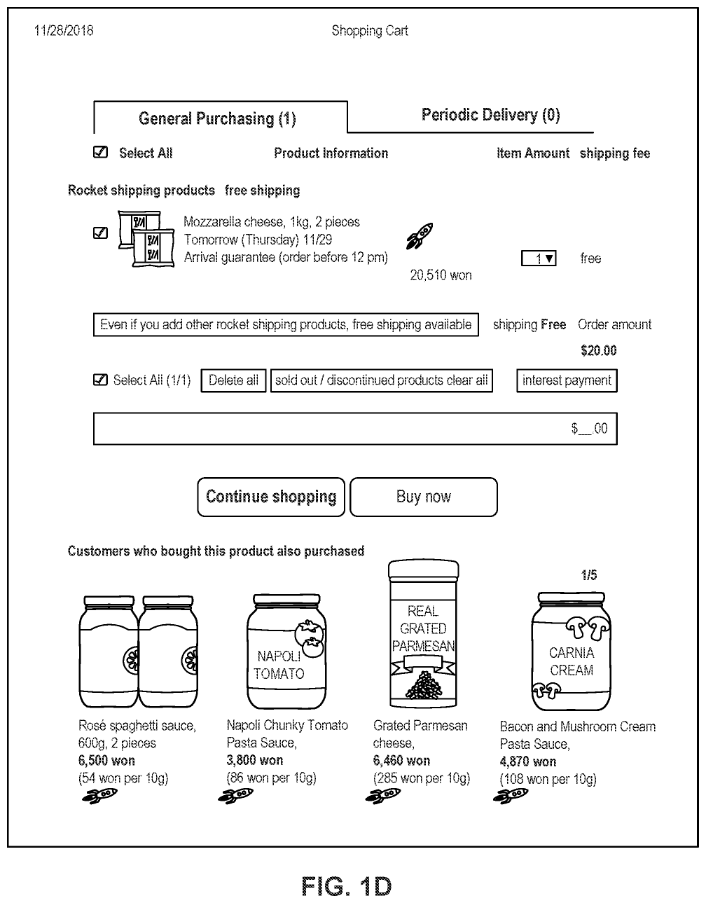

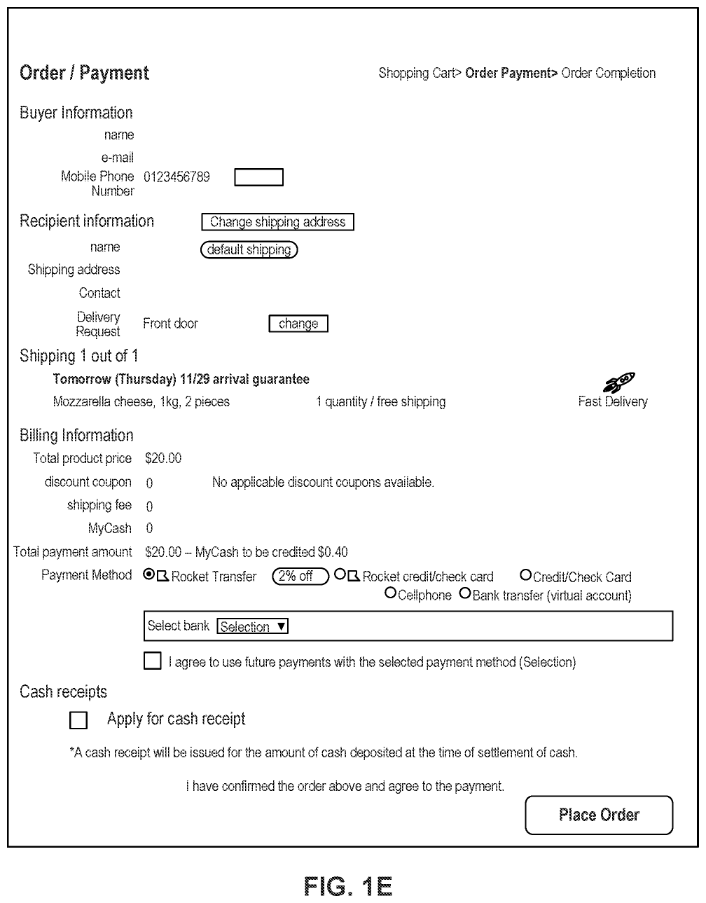

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

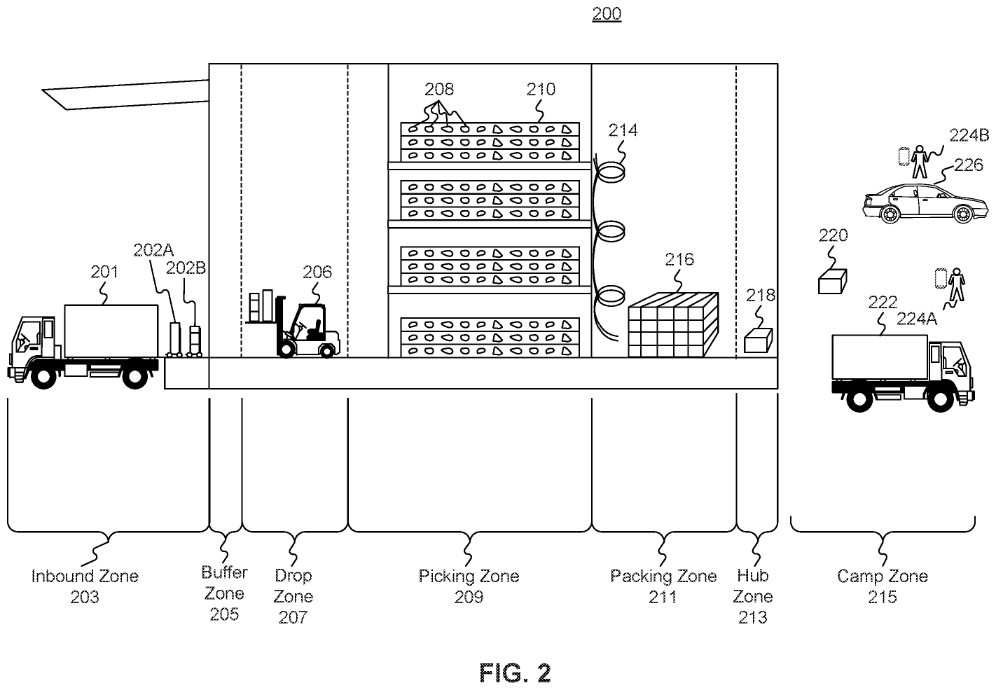

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 2028. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

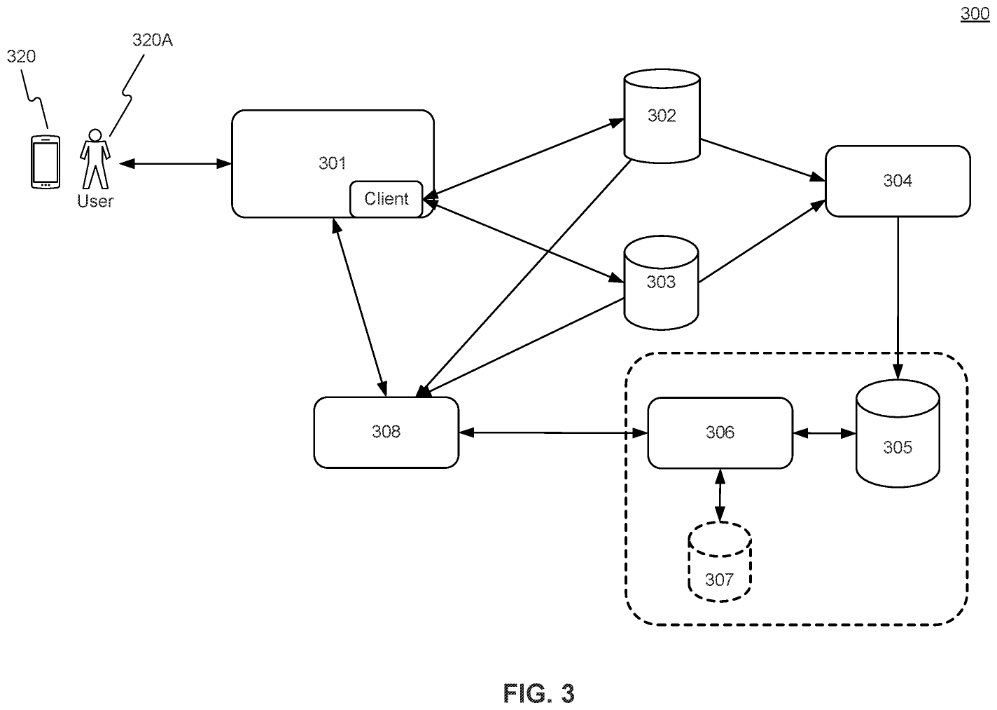

Referring to FIG. 3, an exemplary network of devices and systems for AI-based database parameter optimization is shown. As illustrated in FIG. 3, a system 300 may include an application 301, a database 302, a database 303, a metrics collector system 304, a metrics repository system 305, a model system 306, a testing database 307, and a tuner system 308. Application 301 may communicate with a user device 320 associated with a user 320A or other components of system 300 via a network. In some embodiments, application 301 may communicate with the other components of system 300 via a direct connection, for example, using a cable. In some other embodiments, system 300 may be a part of system 100 of FIG. 1A and may communicate with the other components of system 100 via a network or via a direct connection, for example, using a cable. Application 301 may comprise a single computer or may each be configured as a distributed computer system including multiple computers that interoperate to perform one or more of the processes and functionalities associated with the disclosed examples. In some embodiments, application 301 may include a client component implemented with a specific language (e.g., Java) and a protocol to communicate with external front end system 103 and other components of systems 100 or 300.

System 300 may comprise at least one processor, which may be one or more known processing devices, such as a microprocessor from the Pentium™ family manufactured by Intel™ or the Turion™ family manufactured by AMD™. The processor may constitute a single core or multiple core processor that executes parallel processes simultaneously. For example, the processor may use logical processors to simultaneously execute and control multiple processes. The processor may implement virtual machine technologies or other known technologies to provide the ability to execute, control, run, manipulate, store, etc. multiple software processes, applications, programs, etc. In another example, the processor may include a multiple-core processor arrangement configured to provide parallel processing functionalities to allow system 300 to execute multiple processes simultaneously. One of ordinary skill in the art would understand that other types of processor arrangements could be implemented that provide for the capabilities disclosed herein.

System 300 may comprise at least one memory, which may store one or more operating systems that perform known operating system functions when executed by a processor. By way of example, the operating system may include Microsoft Windows, Unix, Linux, Android, Mac OS, iOS, or other types of operating systems. Accordingly, examples of the disclosed invention may operate and function with computer systems running any type of operating system. The memory may be a volatile or non-volatile, magnetic, semiconductor, tape, optical, removable, non-removable, or other type of storage device or tangible computer readable medium.

Databases 302, 303, or 307 may include, for example, Oracle™ databases, Sybase™ databases, or other relational databases or non-relational databases, such as Hadoop™ sequence files, HBase™, or Cassandra™. In some embodiments, system 300 may include more databases. Databases 302, 303, or 307 may include computing components (e.g., database management system, database server, etc.) configured to receive and process requests for data stored in memory devices of the database(s) and to provide data from the database(s). Databases 302, 303, or 307 may include NoSQL databases such as HBase, MongoDB™ or Cassandra™. Alternatively, databases 302, 303, or 307 may include relational databases such as Oracle, MySQL and Microsoft SQL Server. In some embodiments, databases 302, 303, or 307 may take the form of servers, general purpose computers, mainframe computers, or any combination of these components.

Databases 302, 303, or 307 may store data that may be used by processors for performing methods and processes associated with disclosed examples. Databases 302, 303, or 307 may be located system 300, as shown in FIG. 3, or alternatively, it may be in external storage devices located outside of system 330, query system 300. Data stored in databases 302 or 303 may include queries, query plans, query patterns (e.g., select_name_from_user_where_email=?), query parameters, database workload parameters, optimal parameters, client session database parameters, client session connection pool parameters, client session workload balance parameters, changes in database metrics, current database performance metrics, changes in database performance metrics, client session data, query profiling, system workloads, execution plans, etc. Data stored in database 307 may include historical data, queries, query patterns, query parameters, database workload parameters, featurized queries, optimal parameters, client session database parameters, client session connection pool parameters, client session workload balance parameters, predicted changes in database metrics, changes in database metrics, current database performance metrics, changes in database performance metrics, training data, training targets, model inputs, model outputs, model network weights, error functions, performance scores, client session data, query profiling, system workloads, execution plans, etc. In some embodiments, data stored in databases 302, 303, or 307 may include data from system 100, such as data from external front end system 103, data from FO System 113, data from internal front end system 105, etc.

User device 320 may be a tablet, mobile device, computer, or the like. User device 320 may include a display. The display may include, for example, liquid crystal displays (LCD), light emitting diode screens (LED), organic light emitting diode screens (OLED), a touch screen, and other known display devices. The display may show various information to a user. For example, it may display a user interface element (e.g., on a webpage via external front end system 103 or internal front end system 105), which may include options for submitting queries, options for training models, options for generating training data, options for tuning parameters, etc.

User device 320 may include one or more input/output (I/O) devices. The I/O devices may include one or more devices that allow user device 320 to send and receive information from user 320A or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information within or from system 300 by, for example, establishing wired or wireless connectivity between user device 320 and a network. In some embodiments, user device 320 may include devices of system 100, such as mobile device 102A or computer 102B.

Metrics collector system 304 may collect data (e.g., historical data, queries, query patterns, query parameters, database workload parameters, featurized queries, optimal parameters, client session database parameters, client session connection pool parameters, client session workload balance parameters, predicted changes in database metrics, changes in database metrics, current database performance metrics, changes in database performance metrics, training data, training targets, model inputs, model outputs, model network weights, error functions, performance scores, client session data, query profiling, system workloads, execution plans, etc.) from components of systems 100 or 300 and send the data to metrics repository system 305. In some embodiments, metrics repository system 305 may featurize queries by analyzing the query data, extracting a query plan from the query data, and generating a vector. In some embodiments, metrics repository system 305 may featurize queries by query fingerprinting or query traffic capturing. For example, query fingerprinting may include converting queries into query fingerprints. A query fingerprint is the abstracted form of a query, where abstracting a query includes removing literal values, normalizing whitespace, etc. For example, the query “select name, password from user where id=6” may be converted into a query fingerprint of “password from user where id=?” Abstracted queries allow similar queries to be grouped together.

In some embodiments, user 320A may be an internal user (e.g., employees of an organization that owns, operates, or leases systems 100 or 300) or an external user (e.g., an online shopper).

In some embodiments, user 320A may submit a query to application 301 via user device 320 during a client session. For example, user 320A may use user device 320 to navigate to external front end system 103 and request a search by entering information into a search box on a web page delivered by external front end system 103. External front end system 103 may request information from one or more systems in system 100. For example, external front end system 103 may request information from FO System 113 that satisfies the search request. In some embodiments, external front end system 103 may prepare an SRP (e.g., FIG. 1B) based on the information. The SRP may include information that satisfies the search request. For example, this may include pictures of products that satisfy the search request. In some embodiments, the query may include a plurality of queries or user 320A may submit a plurality of queries. Application 301 may generate a tuning request based on the received query and send the tuning request to tuner system 308. In some embodiments, application 301 may initialize user 320A's client session variables at connect time, thereby customizing predicted optimal parameters according to the client session context (e.g., customizing based on the pattern of the query, the expected size of data to be returned, etc.).

Metrics repository system 305 may preprocess (e.g., transform, clean up, etc.) the query by featurizing the query. Metrics repository system 305 may featurize the query by analyzing the query, extracting a query plan from the query, and generating a vector. In some embodiments, the query plan may include at least one of a query pattern, query parameters (e.g., tables involved in a query, cost of processing a query, query attributes, query types such as insert, delete, select, update, query operations such as selection, join, group by, etc.), or database workload parameters (e.g., number of active connections to be distributed among database servers). In some embodiments, metrics repository system 305 may generate a vector for each query of a plurality of queries in a workload and merge the vectors to generate a single vector. In some embodiments, metrics repository system 305 may generate a vector for each query of a plurality of queries without merging the vectors. In some embodiments, metrics repository system 305 may include a model (e.g., a deep learning model) that learns a discrete value for each parameter of a plurality of queries and classify the queries based on their discrete configuration patterns. In some embodiments, metrics repository system 305 may featurize queries by query fingerprinting or query traffic capturing. For example, query fingerprinting may include converting queries into query fingerprints. A query fingerprint is the abstracted form of a query, where abstracting a query includes removing literal values, normalizing whitespace, etc. For example, the query “select name, password from user where id=6” may be converted into a query fingerprint of “password from user where id=?” Abstracted queries allow similar queries to be grouped together.

In some embodiments, model system 306 may predict, using a model (e.g., a deep reinforcement learning model, neural networks, double-state deep deterministic policy gradient model, etc.), a plurality of optimal parameters for executing the query. The optimal parameters may include at least one of client session database parameters (e.g., buffer size, cache size, working memory), client session connection pool parameters (e.g., maximum active connections distributed among database servers), client session workload balance parameters (e.g., ratio of connection pool for each database server), or data partitioning parameters (e.g., clustering parameters). For example, optimizing client session database parameters, such as buffer size, that are specific to a client session may advantageously reduce latency (e.g., the buffer size may be large enough so that temporary files are not created on disks, but small enough so that memory is not wasted). Similarly, client session connection pool parameters, workload balance parameters, or data partitioning parameters may be optimized improve system performance. For example, the optimal maximum active connections for each database in system 300 may be large enough so that if one database serves a heavier workload, data may be served to another database to reduce latency and database server skews. In some embodiments, optimal data partitioning parameters may include routing strategies so that optimal mechanisms may be chosen at runtime when data distributions change (e.g., during migration, scaling, etc.).

In some embodiments, model system 306 may predict the optimal parameters by calculating, using the model, a predicted change in database metrics (e.g., latency, throughput, etc.) based on the preprocessed query. For example, the model system may predict the difference in database metrics from before execution of the query to after execution of the query. In some embodiments, model system 306 may send the predicted change in database metrics to tuner system 308.

In some embodiments, tuner system 308 may calculate database performance metrics based on the predicted change in database metrics and current database performance metrics. For example, tuner system 308 may calculate database performance metrics by retrieving current (e.g., real-time) database performance metrics from system 300 and adding the predicted change in database metrics to the current database performance metrics.

In some embodiments, tuner system 308 may send the calculated database performance metrics to model system 306 and the model may calculate a vector of optimal parameters based on the calculated database performance metrics. In some embodiments, model system 306 may use a plurality of models. For example, model system 306 may use a first model to calculate the predicted change in database metrics based on the preprocessed query and a second model to calculate the vector of optimal parameters based on the calculated database performance metrics. Model system 306 may input the calculated database performance metrics into the model. The model system may calculate a vector of optimal parameters based on the calculated database performance metrics and send the vector of optimal parameters to tuner system 308. Tuner system 308 may push the optimal parameters to application 301 and execute the query based on the predicted optimal parameters, thereby executing the query using optimal parameters specific to the client session and modifying the client session parameters in runtime. In some embodiments, tuner system 308 may calculate a performance score associated with the executed query. For example, the performance score may be calculated by determining a change in database performance metrics resulting from the executed query.

In some embodiments, tuner system 308 may send the performance score to the model in model system 306. Model system 306 may update the network weights of the model based on the performance score.

In some embodiments, model system 306 may generate training data by retrieving data stored in databases 302, 303, or 307, metrics collector system 304, or data from tuner system 308. In some embodiments, model system 306 may generate training data by retrieving current client session data (e.g., real-time data) from databases 302 or 303 or historical data from database 307 and featurizing the retrieved data. For example, training data may include historical data form client sessions or real-time data from current client sessions (query pattern, query parameters, tables involved in a query, cost of processing a query, query attributes, query types such as insert, delete, select, update, query operations such as selection, join, group by, database workload parameters, number of active connections to be distributed among database servers, query vectors, query configuration patterns, optimal parameters, buffer size, cache size, working memory, client session connection pool parameters, maximum active connections distributed among database servers, client session workload balance parameters, ratio of connection pool for each database server, predicted changes in database metrics, preprocessed queries, calculated database performance metrics, actual database performance metrics, performance scores, etc.). Featurizing the retrieved data may include analyzing the data, extracting a query plan from the data, and generating a vector. In some embodiments, model system 306 may generate training data by inputting featurized retrieved data into a model and determining changes in performance metrics from the model, where the determined changes in performance metrics may be training data. In some embodiments, metrics repository system 305 may featurize queries by query fingerprinting or query traffic capturing. For example, query fingerprinting may include converting queries into query fingerprints. A query fingerprint is the abstracted form of a query, where abstracting a query includes removing literal values, normalizing whitespace, etc. For example, the query “select name, password from user where id=6” may be converted into a query fingerprint of “password from user where id=?” Abstracted queries allow similar queries to be grouped together.

In some embodiments, model system 306 may train the model by retrieving training data, defining a training target, running the model using the training data, and iteratively updating network weights of the model until the model outputs the training target. In some embodiments, the training target may include a minimization of an error function. In some embodiments, the model may be trained by randomly selecting training data.

In some embodiments, the model may be a multilayer perceptron model composed of four fully connected layers. In some embodiments, model system 306 may generate the model based on the scale of the input or output vectors (e.g., to determine the number of neurons in each layer of the model). The input layer of the model may accept the feature vector and output a mapped tensor (e.g., higher dimensions) to hidden layers. The hidden layers may include a series of non-linear data transformations. The output may restrict the tensor to the scale of the database and generate a vector representing the predicted change in database metrics. The network may represent a chain of function compositions, which transform the input to the output space (e.g., a pattern). In some embodiments, the model may include an activation function (e.g., ReLU) in the hidden layers to capture more patterns. In some embodiments, the weights in the network may be initialized by a standard normal distribution.

In some embodiments, model system 306 may map queries to discrete configuration patterns. For example, an input layer of the model may receive a feature vector as an input and map the feature vector to a target parameter space in order to scale the output. The second layer may be a dense layer with an activation function (e.g., ReLU) that captures the correlations among input features (e.g., the value difference of a feature when other features change) or the mapping relations between the input vector and the output vector. Subsequent layers may normalize the input vector in favor of gaining discretized results and use a sigmoid activation function to receive a real value as an input and output a value in “0” to “1.” In some embodiments, the output layer of the model may be used as a probability distribution function, where for each feature in the output vector, the resulting bit is “−1” if the feature is below 0.5, “0” if the feature equals 0.5, or “1” otherwise. In some embodiments, the model may propagate the features through a network, output a query pattern, and update the network weights of the model by minimize the difference between the output query pattern and the actual query pattern.

In some embodiments, model system 306 may train the model by using a stochastic optimization algorithm (e.g., Adaptive Moment Estimation), which iteratively updates the network weights by first and second moments of gradients, which may be computed using a stochastic objective function. The training may terminate if the model is converged or runs a given number of steps. For example, the model may be converted when the change in performance metrics reaches the training target (e.g., when the change in performance metrics is less than a threshold, greater than a threshold, etc.).

In some embodiments, model system 306 may classify queries into different cluster based on the similarity of query patterns. For example, clustering algorithms (e.g., density-based spatial clustering of applications with noise) may be used to cluster the configurations and based on the configuration pattern, where model system 306 may group the patterns together that are close to each other according to a distance measurement and the minimum number of points to be clustered together.

In some embodiments, model system 306 may periodically retrieve data (e.g., real-time data, historical data, etc.), run the model, and push predicted optimal parameters to application 301. Application 301 may receive the predicted optimal parameters and refresh the database configuration using the optimal parameters in runtime.

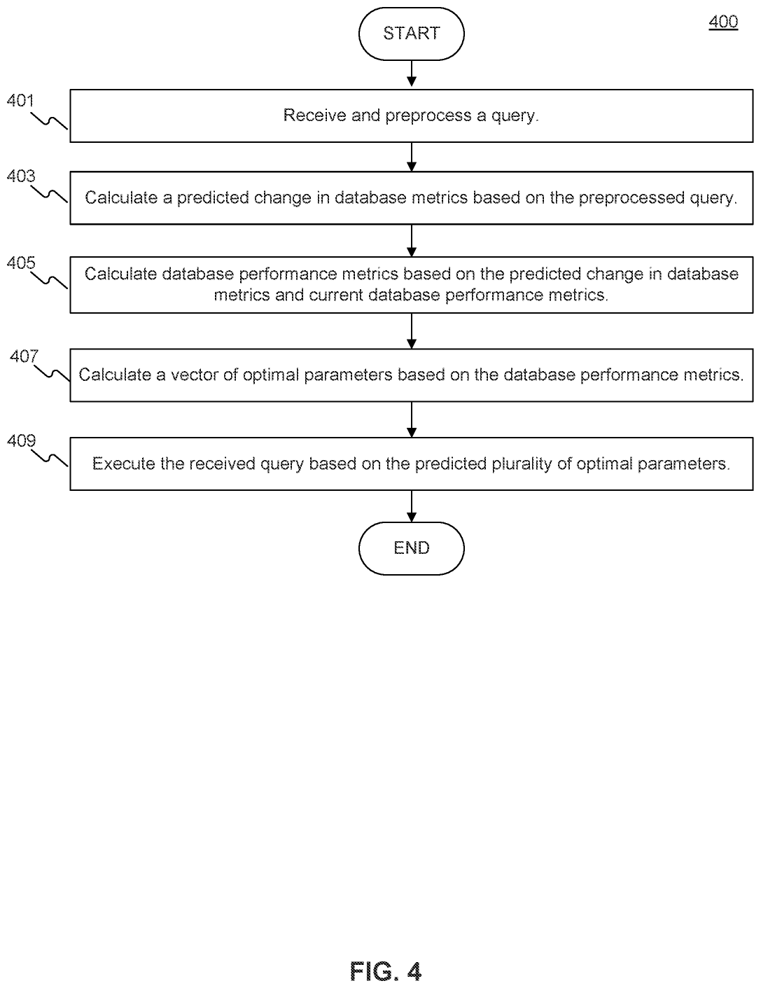

Referring to FIG. 4, a process 400 for AI-based database parameter optimization is shown. While in some embodiments in system 330 may perform several of the steps described herein, other implementations are possible. For example, any of the systems and components (e.g., system 100) described and illustrated herein may perform the steps described in this disclosure.

In step 401, user 320A may submit a query to application 301 via user device 320 during a client session. In some embodiments, the query may include a plurality of queries or user 320A may submit a plurality of queries. Application 301 may generate a tuning request based on the received query and send the tuning request to tuner system 308. In some embodiments, application 301 may initialize user 320A's client session variables at connect time, thereby customizing predicted optimal parameters according to the client session context (e.g., customizing based on the pattern of the query, the expected size of data to be returned, etc.).

Metrics repository system 305 may preprocess (e.g., transform, clean up, etc.) the query by featurizing the query. Metrics repository system 305 may featurize the query by analyzing the query, extracting a query plan from the query, and generating a vector. In some embodiments, the query plan may include at least one of a query pattern, query parameters (e.g., tables involved in a query, cost of processing a query, query attributes, query types such as insert, delete, select, update, query operations such as selection, join, group by, etc.), or database workload parameters (e.g., number of active connections to be distributed among database servers). In some embodiments, metrics repository system 305 may featurize queries by query fingerprinting or query traffic capturing. For example, query fingerprinting may include converting queries into query fingerprints. A query fingerprint is the abstracted form of a query, where abstracting a query includes removing literal values, normalizing whitespace, etc. For example, the query “select name, password from user where id=6” may be converted into a query fingerprint of “password from user where id=?” Abstracted queries allow similar queries to be grouped together.

In step 403, model system 306 may predict optimal parameters by calculating, using the model, a predicted change in database metrics (e.g., latency, throughput, etc.) based on the preprocessed query. For example, the model system may predict the difference in database metrics from before execution of the query to after execution of the query. In some embodiments, model system 306 may send the predicted change in database metrics to tuner system 308.

In some embodiments, model system 306 may predict, using a model (e.g., a deep reinforcement learning model, neural networks, double-state deep deterministic policy gradient model, etc.), a plurality of optimal parameters for executing the query. The optimal parameters may include at least one of client session database parameters (e.g., buffer size, cache size, working memory), client session connection pool parameters (e.g., maximum active connections distributed among database servers), client session workload balance parameters (e.g., ratio of connection pool for each database server), or data partitioning parameters (e.g., clustering parameters).

For example, optimizing client session database parameters, such as buffer size, that are specific to a client session may advantageously reduce latency (e.g., the buffer size may be large enough so that temporary files are not created on disks, but small enough so that memory is not wasted). Similarly, client session connection pool parameters, workload balance parameters, or data partitioning parameters may be optimized improve system performance. For example, the optimal maximum active connections for each database in system 300 may be large enough so that if one database serves a heavier workload, data may be served to another database to reduce latency and database server skews. In some embodiments, optimal data partitioning parameters may include routing strategies so that optimal mechanisms may be chosen at runtime when data distributions change (e.g., during migration, scaling, etc.).

In step 405, tuner system 308 may calculate database performance metrics based on the predicted change in database metrics and current database performance metrics. For example, tuner system 308 may calculate database performance metrics by retrieving current (e.g., real-time) database performance metrics from system 300 and adding the predicted change in database metrics to the current database performance metrics. In some embodiments, tuner system 308 may send the calculated database performance metrics to model system 306.

In Step 407, the model system may calculate a vector of optimal parameters based on the calculated database performance metrics. In some embodiments, model system 306 may use a plurality of models to perform steps of process 400. For example, model system 306 may use a first model to calculate the predicted change in database metrics based on the preprocessed query and a second model to calculate the vector of optimal parameters based on the calculated database performance metrics. Model system 306 may input the calculated database performance metrics into the model. The model system may calculate a vector of optimal parameters based on the calculated database performance metrics and send the vector of optimal parameters to tuner system 308.

In step 409, tuner system 308 may push the optimal parameters to application 301 and execute the query based on the predicted optimal parameters, thereby executing the query using optimal parameters specific to the client session and modifying the client session parameters in runtime. In some embodiments, tuner system 308 may calculate a performance score associated with the executed query. For example, the performance score may be calculated by determining a change in database performance metrics resulting from the executed query. In some embodiments, tuner system 308 may send the performance score to the model in model system 306. Model system 306 may update the network weights of the model based on the performance score.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for AI-based database parameter optimization, the system comprising:
a memory storing instructions; and
at least one processor configured to execute the instructions to:
initialize a client session comprising a context and a variable, the variable associated with a user device;
receive, from the user device, a query;
preprocess the query;
predict a plurality of optimal parameters for executing the query, the plurality of optimal parameters being customized according to a client session context associated with the client session variable by:
calculating a predicted change in database metrics based on the preprocessed query;
calculating database performance metrics based on the predicted change in database metrics and the current database performance metrics; and
calculating a vector of optimal parameters based on the database performance metrics,
wherein customizing according to the client session context associated with the client session variable comprises customizing based on an expected size of data to be returned according to a client session, and
the plurality of optimal parameters comprises a buffer size associated with the client session; and
execute the received query by applying route strategies for varying data distribution based on the predicted plurality of optimal parameters customized according to the client session context.

2. The system of claim 1, wherein preprocessing the query comprises featurizing the query.

3. The system of claim 2, wherein featurizing the query comprises:
analyzing the query;
extracting a query plan from the query; and
generating a vector.

4. The system of claim 3, wherein the query plan comprises at least one of a query pattern, query parameters, database workload parameters.

5. The system of claim 1, wherein the plurality of optimal parameters comprise at least one of client session database parameters, client session connection pool parameters, or client session workload balance parameters.

6. The system of claim 1, further comprising a training model, wherein training the model comprises:
retrieving training data;
defining a training target;
running the model using the training data; and
iteratively updating network weights of the model until the model outputs the training target;

7. The system of claim 6, wherein the training target comprises a minimization of an error function.

8. The system of claim 6, wherein training the model further comprises generating the training data.

9. The system of claim 8, wherein generating the training data comprises:
retrieving historical data from a database; and
featurizing the historical data.

10. The system of claim 9, wherein featurizing the historical data comprises:
analyzing the historical data;
extracting a query plan from the historical data; and
generating a vector.

11. A method for AI-based database parameter optimization, comprising:
initialize a client session comprising a context and a variable, the variable associated with a user device;
receiving from the user device, a query;
preprocessing the query;
predicting a plurality of optimal parameters for executing the query, the plurality of optimal parameters being customized according to a client session context associated with the client session variable, by:
calculating a predicted change in database metrics based on the preprocessed query;
calculating database performance metrics based on the predicted change in database metrics and current database performance metrics; and
calculating a vector of optimal parameters based on the database performance metrics,
wherein customizing according to the client session context associated with the client session variable comprises customizing based on an expected size of data to be returned according to a client session, and
the plurality of optimal parameters comprises a buffer size associated with the client session; and
executing the received query by applying routing strategies for varying data distribution based on the predicted plurality of optimal parameters customized according to the client session context.

12. The method of claim 11, wherein preprocessing the query comprises featurizing the query.

13. The method of claim 12, wherein featurizing the query comprises:
analyzing the query;
extracting a query plan from the query; and
generating a vector.

14. The method of claim 11, wherein the plurality of optimal parameters comprise at least one of client session database parameters, client session connection pool parameters, or client session workload balance parameters.

15. The method of claim 11, further comprising training a model, wherein training the model comprises:
retrieving training data;
defining a training target;
running the model using the training data; and
iteratively updating network weights of the model until the model outputs the training target.

16. The method of claim 15, wherein the training target comprises a minimization of an error function.

17. The method of claim 15, wherein training the model further comprises generating the training data.

18. The method of claim 17, wherein generating the training data comprises:
retrieving historical data from a database; and
featurizing the historical data.

19. The method of claim 18, wherein featurizing the historical data comprises:
analyzing the historical data;
extracting a query plan from the historical data; and
generating a vector.

20. A computer-implemented system for AI-based database parameter optimization, the system comprising:
a memory storing instructions; and
at least one processor configured to execute the instructions to:
initialize a client session comprising a context and a variable, the variable associated with a user device;
receive, from the user device, a query;
preprocess the query;
predict, using a model, a plurality of optimal parameters for executing the query, the plurality of optimal parameters being customized according to a client session context associated with the client session variable, by:
calculating, using the model, a predicted change in database metrics based on the preprocessed query;
sending the predicted change in database metrics to a tuner;
calculating, using the tuner, database performance metrics based on the predicted change in database metrics and current database performance metrics; and
calculating, using the model, a vector of optimal parameters based on the database performance metrics,
wherein customizing according to the client session context associated with the client session variable comprises customizing based on an expected size of data to be returned according to a client session, and
the plurality of optimal parameters comprises a buffer size associated with the client session;
execute, using the tuner, the received query by applying routing strategies for varying data distribution based on the predicted plurality of optimal parameters customized according to the client session context;
calculating, using the tuner, a performance score associated with the executed query;
sending the performance score to the model; and
updating network weights of the model based on the performance score.
